(19) United States
(12) Patent Application Publication
(10) Pub. No.: US 2026/0067682 A1
(43) Pub. Date: Mar. 5, 2026

(54) PTK DERIVATION DURING LINK ADD PROCEDURE

(71) Applicant: APPLE INC., Cupertino, CA (US)

(72) Inventors: Chittabrata Ghosh, Fremont, CA (US); Yong Liu, Campbell, CA (US); Jarkko L. Kneckt, Los Gatos, CA (US); Pooya Monajemi, San Jose, CA (US); Anuj Batra, Redwood City, CA (US)

(21) Appl. No.: 19/280,451

(22) Filed: Jul. 25, 2025

Related U.S. Application Data
(60) Provisional application No. 63/687,536, filed on Aug. 27, 2024.

(51) Int. Cl. H04W 12/041; H04L 9/30; H04L 9/32; H04W 8/12; H04W 84/12

(52) U.S. Cl. CPC H04W 12/041; H04L 9/3013; H04L 9/321; H04W 8/12; H04W 84/12

(57) ABSTRACT

Embodiments herein provide systems, methods, and apparatuses for a non-access point station (STA) to roam between access points (APs). In some embodiments, the STA may send a first management frame to a serving AP, the first management frame including an identifier for a target AP and a first container with STA security context. The STA may receive a second management frame including a second container with security context for the target AP. The STA may derive a temporal key for communication with the target AP, and establish a second link with the target AP before breaking the first link with the serving AP.

### TECHNICAL FIELD

This application relates generally to wireless communication systems, including security for seamless roaming between access points.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example signal flow diagram for FT over-the-Distribution System (DS) protocol, in accordance with some embodiments.

FIG. 2 illustrates an example signal flow diagram for a link addition procedure before route switch, in accordance with some embodiments.

FIG. 3 illustrates an example signal flow diagram for PTK computation during a link addition procedure before route switch, in accordance with some embodiments.

FIG. 4 illustrates an example signal flow diagram for PTK computation during a link addition procedure before route switch using FILS authentication, in accordance with some embodiments.

FIG. 5 illustrates an example signal flow diagram for PTK computation during a link addition procedure before route switch using an SRE carried in the link addition request and response frames, in accordance with some embodiments.

FIG. 6 illustrates an example signal flow diagram for PTK computation during a link addition procedure and PTK verification, in accordance with some embodiments.

FIG. 7 illustrates an example signal flow diagram for PTK verification after PTK derivation, in accordance with some embodiments.

FIG. 8 illustrates a flow chart of an example method performed by an STA (e.g., non-AP MLD), in accordance with some embodiments.

FIG. 9 illustrates a flow chart of an example method performed by a serving AP, in accordance with some embodiments.

FIG. 10 illustrates a flow chart of an example method performed by a target AP, in accordance with some embodiments.

FIG. 11 illustrates an example system for performing signaling between a wireless device and a network device, according to embodiments disclosed herein.

### DETAILED DESCRIPTION

Wireless communication technology uses various standards and protocols to transmit data between an access point and a wireless communication device. One standard that is used for wireless communication is the Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device (e.g., a station) may connect to a Wi-Fi® access point to join a network and connect to the internet wirelessly. Wi-Fi® security is important to protect data and devices from unauthorized access.

Various embodiments are described with regard to a non-access point (non-AP) (e.g., station (STA)) and an Access Point (AP). However, reference to an STA and AP is provided merely for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

Seamless roaming refers to the ability of a device to move between different APs within the same network without experiencing noticeable interruptions in the connection. This technology is particularly useful in environments with multiple APs (like large offices, campuses, or homes with mesh networks) where users move around frequently.

As part of the seamless roaming, a Pairwise Transient Key (PTK) is established and used to protect frames. Some embodiments herein provide enhancements to PTK derivation between a non-AP Multi-Link Device (MLD) and a Roaming Target AP MLD using link addition signaling.

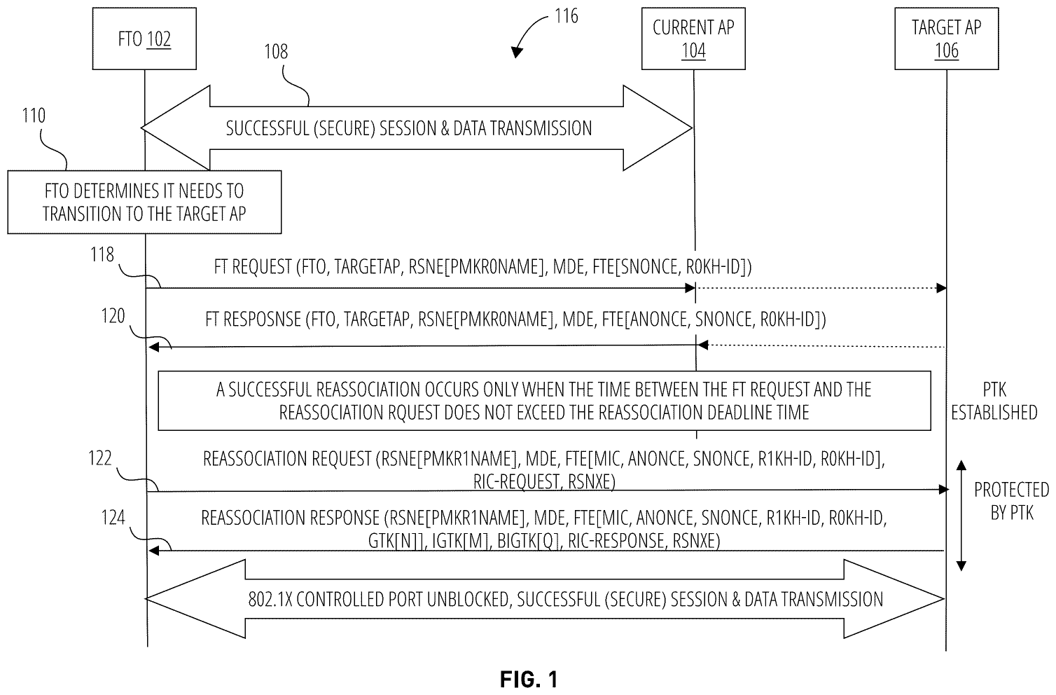

To implement seamless roaming Wi-Fi® systems may use fast Basic Service Sets (BSS) transition (FT) for quick and secure handoffs between APs. FIG. 1 illustrates an example signal flow diagram 116 for FT over-the-Distribution System (DS) protocol, in accordance with some embodiments. FT is a specific method defined within the IEEE 802.11 standard for facilitating fast and secure roaming between Wi-Fi APs. In the illustrated embodiment, an FT Originator (FTO) 102 uses FT to switch from a current AP 104 to a target AP 106.

The FTO 102 may be a non-AP device such as a cellular phone, tablet, laptop, or other STA device. The FTO 102 may establish 108 a successful (secure) session with the current AP 104. The FTO 102 and the current AP 104 may send data transmissions using the session. If the FTO 102 moves, the signal strength of the current AP 104 may decrease and the signal strength of the target AP 106 may be stronger.

When the FTO 102 moves from the coverage area of one AP to another, the FTO 102 may determine 110 it needs to transition to the target AP 106. The FTO 102 may send an authentication request (e.g., FT request 118) to the current AP MLD (e.g., current AP 104). The authentication request may include an identifier of the target AP 106 (e.g., TargetAP); a Robust Security Network Element (RSNE) that includes security parameters (e.g., Pairwise Master Key R0 Name (PMKR0Name)); a Mobility Domain element (MDE); and FT element (FTE) with Supplicant Nonce (SNonce) and R0 Key Holder Identifier (R0KH-ID). Further, for the authentication request, the source address (SA) field is set to Media Access Control (MAC) address of the FTO 102, and destination address (DA) is set to Basic Service Set Identifier (BSSID) of target AP MLD's BSS.

The current AP 104 can forward the authentication request to the target AP 106 over backhaul. The target AP 106 can share security content with the current AP 104 using remote requests that may include MDE and FTE with Authenticator Nonce (ANonce), SNonce, R1KH-ID, and R0KH-ID. The current AP 104 may send the FTO 102 a FT response 120 that includes RSNE that includes PMKR0Name, MDE, and FTE that includes ANonce, SNonce, R1KH-ID, R0KH-ID.

The FTO 102 and target AP 106 compute PTK and PTKName using PMK-R1, PMKR1Name, ANonce, SNonce. The PTK is used to protect the reassociation transaction that includes the reassociation request 122 and the reassociation response 124. In some embodiments, a successful reassociation occurs only when the time between the FT request 118 and the reassociation request 122 does not exceed the reassociation deadline time.

Some benefits of the FT procedure include that SNonce and ANonce can enable reply protection and PTK separation from the Serving AP MLD. However, a disadvantage of the FT procedure is that breaking communication with current AP 104 when FTO 102 sends reassociation request 122 frame to the Target AP 106 may cause data loss. For example, the FTO 102 may break the connection with the current AP 104 when it sends the reassociation request 122. When the connection is broken, the current AP 104 does not see the FTO 102 in its network and so the current AP 104 may flush packets that are buffered for the FTO 102. Those flushed packets correspond to lost downlink data for the FTO 102. This type of handover process may be referred to as break-before-make (e.g., an old connection breaks before a new connection is made).

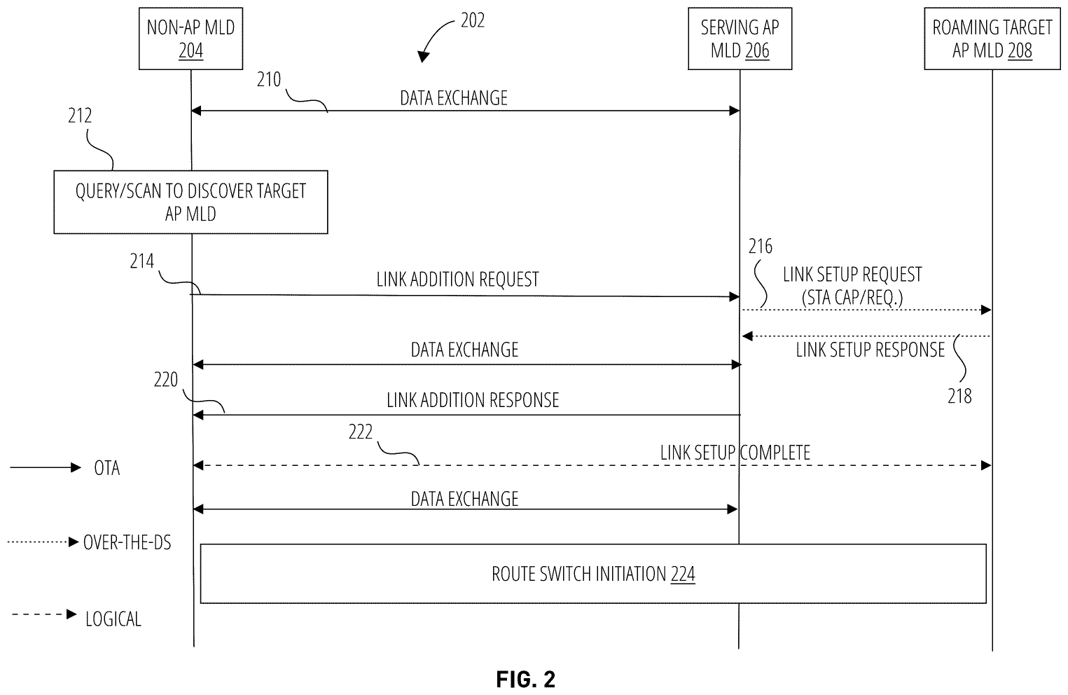

To prevent the data loss, some systems may use a make-before-break procedure (e.g., make a new connection before breaking an old connection). For example, FIG. 2 illustrates an example signal flow diagram 202 for a link addition procedure before route switch, in accordance with some embodiments. The link addition procedure may allow the non-AP MLD 204 to establish a connection with the roaming target AP MLD 208 before breaking the connection with the serving AP MLD 206.

In the illustrated embodiment, the non-AP MLD 204 and the serving AP MLD 206 may have an established session and exchange data 210. The non-AP MLD 204 may query/scan 212 to discover roaming Target AP MLD 208. The roaming target AP MLD 208 may represent an AP that the non-AP MLD 204 identifies as having a better signal strength than the serving AP MLD 206.

The non-AP MLD 204 may initiate roaming through the serving AP MLD 206. The non-AP MLD 204 sends a link addition request 214 to the serving AP MLD 206 with the roaming target AP MLD identifier. This link addition request 214 may inform the serving AP MLD 206 of a desire of the non-AP MLD 204 to roam to the roaming target AP MLD 208 as indicated by the identifier in the link addition request 214. The link addition request 214 may be sent as an over-the-air transmission.

Upon receipt of the link addition request 214, the serving AP MLD 206 can send a link setup request frame 216 to the indicated roaming target AP MLD 208. The link setup request frame 216 may include non-AP MLD requirements, capabilities, and PTK. The link setup request frame 216 may be sent over-the-DS.

The roaming target AP MLD 208 may send the serving AP MLD 206 a link setup response 218. The link setup response 218 may include a decision about the link addition request 214 from the non-AP MLD 204. The decision may indicate whether the roaming target AP MLD 208 accepts the request or not. The link setup response 218 from the roaming target AP MLD 208 to the serving AP MLD 206 may be sent over-the-DS.

The serving AP MLD 206 may send the link addition response frame 220 to the non-AP MLD 204 over-the-air. Link setup is complete 222 with the roaming target AP MLD 208 after reception of the link addition response frame 220 from serving AP MLD 206. The non-AP MLD and Roaming target AP MLD are in State 4. As shown, the non-AP MLD 204 and the roaming target AP MLD 208 establish a logical connection. As the serving AP MLD 206 and the non-AP MLD 204 are still connected, they may continue to exchange data. The non-AP MLD 204 may initiate a route switch 224 to the roaming target AP MLD 208 via the already established link.

Such a procedure may be beneficial, as it maintains communication with serving AP MLD 206 while links are added with roaming target AP MLD 208. This may prevent lost data. However, a potential disadvantage is that security may be compromised with PTK sharing as static context.

Embodiments herein may include the sharing of security context to enhance the link addition procedure. Some embodiments may implement a new PTK computation during the link addition phase (e.g., link addition request and link addition response). For instance, a non-AP MLD may derive a new temporal key (PTK) with a roaming target AP MLD during the link addition phase. This may be beneficial, as it may maintain the communication with the serving AP MLD while adding a link with the roaming target AP MLD. Such enhancements may also enable liveness proof, replay protection, and PTK separation. In some embodiments, the STA shares its keyholder identifier (e.g., R0KH-ID) with the serving AP MLD (which forwards R0KH-ID to the target AP MLD), the target AP MLD shares its keyholder identifier R1KH-ID with the serving AP MLD (which forwards R0KH-ID to the STA), and the R0KH-ID and R1KH-ID are used by non-AP MLD and target AP MLD to derive the PTK.

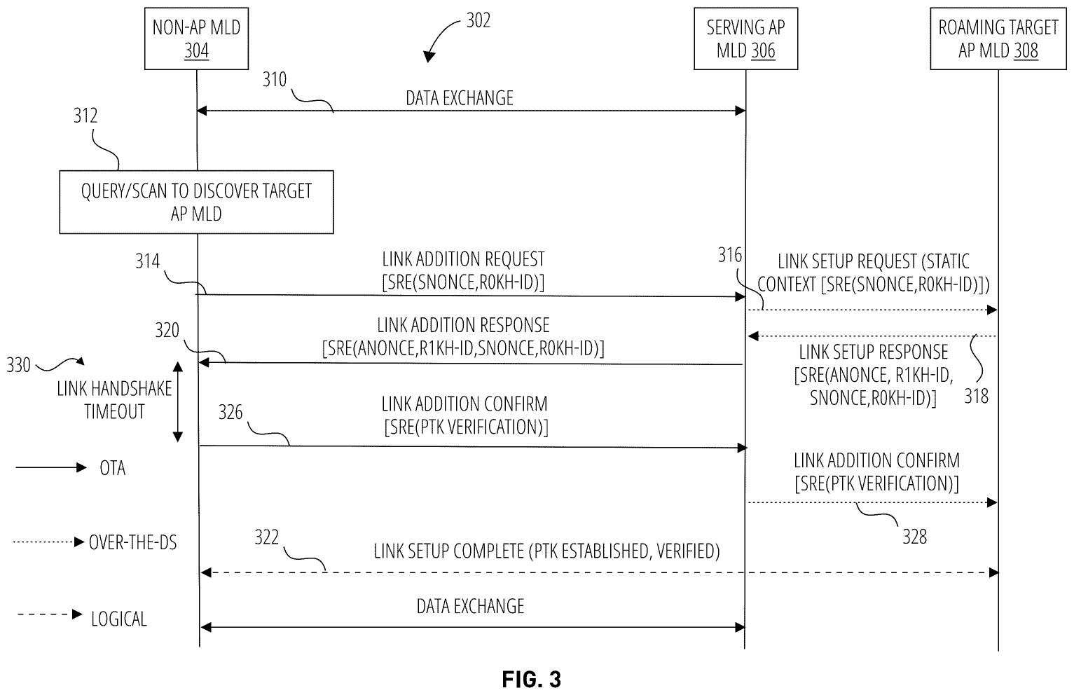

FIG. 3 illustrates an example signal flow diagram 302 for PTK computation during a link addition procedure before route switch, in accordance with some embodiments. The link addition procedure may allow the non-AP MLD 304 to establish a connection with the roaming target AP MLD 308 before breaking the connection with the serving AP MLD 306. Further, the illustrated procedure introduces a container that includes security context (e.g., a seamless roaming element (SRE)) carried in management frames (e.g., link addition request and response action frames).

In the illustrated embodiment, the non-AP MLD 304 and the serving AP MLD 306 may have an established session and exchange data 310. The non-AP MLD 304 may query/scan 312 to discover roaming target AP MLD 308. The roaming target AP MLD 308 may represent an AP that the non-AP MLD 304 identifies as having a better signal strength than the serving AP MLD 306.

The non-AP MLD 304 may initiate roaming (e.g., transition from the serving AP MLD 306 to the roaming target AP MLD 308) through the serving AP MLD 306. The non-AP MLD 304 can send a management frame, such as a link addition request frame 314, to the serving AP MLD 306 with the roaming target AP MLD identifier. This link addition request frame 314 may inform the serving AP MLD 306 of a desire of the non-AP MLD 304 to roam to the roaming target AP MLD 308, as indicated by the identifier in the link addition request frame 314. The link addition request frame 314 may be sent as an over-the-air transmission.

Further, the link addition request frame 314 may include an SRE. The SRE may include security context. The security context included in the SRE of the link addition request frame 314 may include SNonce and R0KH-ID. The serving AP MLD 306 may receive the link addition request frame 314 and tunnel the information over-the-DS. For example, as shown, the serving AP MLD 306 may send the roaming target AP MLD 308 a link setup request 316 that includes the SRE with the SNonce and R0KH-ID.

The roaming target AP MLD 308 may send the serving AP MLD 306 a link setup response 318 over-the-DS. The link setup response 318 may include a decision concerning the link addition request frame 314 from the non-AP MLD 304. The decision may indicate whether the roaming target AP MLD 308 accepts the request or not. If the decision is to accept the link addition request frame 314 and create a link with the non-AP MLD 304, the link setup response 318 may include a container with security context for the roaming target AP MLD 308. For example, the link setup response 318 may include an SRE that includes ANonce, R1KH-ID, SNonce, and R0KH-ID.

The serving AP MLD 306 may send the link addition response frame 320 with the SRE to the non-AP MLD 304 over-the-air. The link addition response frame 320 sent from the serving AP MLD 306 may include all the security context that the roaming target AP MLD 308 included in the over-the-DS link setup response 318 (e.g., ANonce, R1KH-ID, SNonce, and R0KH-ID).

The security context shared from the non-AP MLD 304 and the roaming target AP MLD 308 may provide the parameters to compute a PTK. Accordingly, upon receipt of the security context, non-AP MLD 304 and Roaming target AP MLD 308 may compute the PTK. The PTK may be used in data encryption and decryption processes for communications between the roaming target AP MLD 308 and the non-AP MLD 304.

In some embodiments, the non-AP MLD 304 may determine whether the PTK it computed is correct. For example, the non-AP MLD 304 may send a link addition confirm frame 326 to the serving AP MLD 306. The non-AP MLD 304 may forward the information from the link addition confirm frame 326 over-the-DS to the roaming target AP MLD 308 (e.g., link addition confirm 328). The link addition confirm frame 326 may include PTK verification information. For example, the link addition confirm frame 326 may include a container (e.g., an SRE) that includes the PTK verification information. If the PTK calculated by the non-AP MLD 304 is incorrect, the roaming target AP MLD 308 may indicate that the PTK is wrong. If the PTK calculated by the non-AP MLD 304 is correct, the roaming target AP MLD 308 may respond with an acknowledgement (ACK) message, or the roaming target AP MLD 308 may not provide feedback. In some embodiments, the roaming target AP MLD 308 only sends a response frame to the link addition confirm 328 when the PTK verification information is incorrect.

In some embodiments, a link handshake timeout 330 may be used. The link handshake timeout 330 may define a value after which PTK and context for link setup are expired. The link handshake timeout 330 may refer to a maximum duration between the link addition response frame 320 and the link addition confirm frame 326. In some embodiments, the serving AP MLD 306 may include the timeout value to the non-AP MLD 304 in link addition response frame 320. The roaming target AP MLD 308 and the non-AP MLD 304 may set a timer equal to the link handshake timeout 330. If the link addition confirm frame is not received by the roaming target AP MLD 308 within the indicated link handshake timeout 330, the newly derived PTK and context for link setup may be considered expired.

Link setup may be complete 322 with the roaming target AP MLD 308 after the PTK is established and verified. As shown, the non-AP MLD 304 and the roaming target AP MLD 308 establish a logical connection. As the serving AP MLD 306 and the non-AP MLD 304 are still connected, they may continue to exchange data. The non-AP MLD 304 may initiate a route switch to the roaming target AP MLD 308 via the already established link.

The illustrated embodiment may PTK derivation during the link add procedure for seamless roaming. As shown, the security context may be exchanged between non-AP MLD 304 and Serving AP MLD 306 during the link add procedure. Further, in some embodiments, a timeout value may be used for liveness proof and PTK separation.

In the signal flow diagram 302, the serving AP MLD 306 receives keys from both the non-AP MLD 304 and the roaming target AP MLD 308, and is able to use the keys to also generate the PTK. This may allow the serving AP MLD 306 to be able to decrypt communication between the signal flow diagram 302 and the serving AP MLD 306.

Additional procedures may be implemented to prevent the serving AP MLD from being able to generate the PTK. In some embodiments, a non-AP MLD may derive a new temporal key (e.g., PTK) with Roaming Target AP MLD during the link addition phase (e.g., link addition request and link addition response) using Fast Initial Link Setup (FILS) authentication. Such embodiments may maintain the communication with a serving AP MLD while adding a link with the roaming target AP MLD; and the serving AP MLD may not be able to derive the PTK without knowledge of the non-AP MLD and roaming target AP MLD's private keys. To implement the FILS authentication in the link addition phase, the ephemeral private keys of the non-AP MLD and roaming target AP MLD may not be shared with serving AP MLD. Instead, the non-AP MLD and roaming target AP MLD may share their ephemeral public key (EPK) with the serving AP MLD. The roaming target AP MLD may use the non-AP MLD's EPK and its own ephemeral private key to derive an ephemeral Diffie-Hellman shared secret (DHss). Further, the non-AP MLD may use the target AP MLD's EPK and its own ephemeral private key to derive an ephemeral Diffie-Hellman shared secret (DHss).

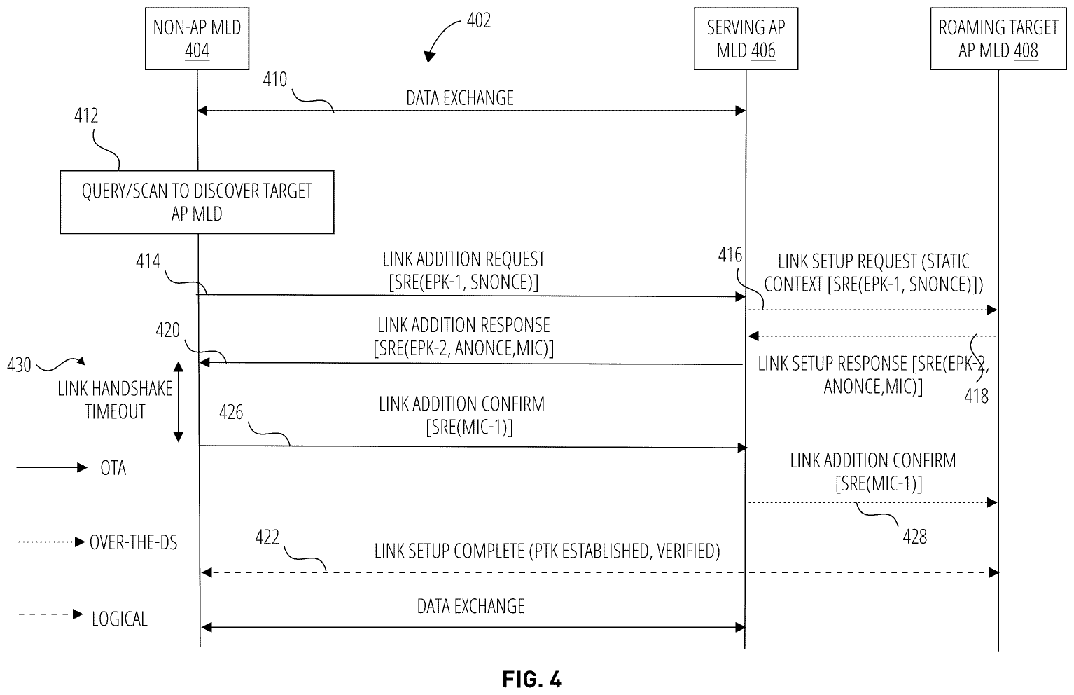

FIG. 4 illustrates an example signal flow diagram 402 for PTK computation during a link addition procedure before route switch using FILS authentication, in accordance with some embodiments. The link addition procedure may allow the non-AP MLD 404 to establish a connection with the roaming target AP MLD 408 before breaking the connection with the serving AP MLD 406. Further, the illustrated procedure introduces a container that includes security context (e.g., a seamless roaming element (SRE)) carried in management frames (e.g., link addition request and response action frames) using FILS authentication.

In the illustrated embodiment, the non-AP MLD 404 and the serving AP MLD 406 may have an established session and exchange data 410. The non-AP MLD 404 may query/scan 412 to discover roaming target AP MLD 408. The roaming target AP MLD 408 may represent an AP that the non-AP MLD 404 identifies as having a better signal strength than the serving AP MLD 406.

The non-AP MLD 404 may initiate roaming (e.g., transition from the serving AP MLD 406 to the roaming target AP MLD 408) through the serving AP MLD 406. The non-AP MLD 404 can send a management frame, such as a link addition request frame 414, to the serving AP MLD 406 with the roaming target AP MLD identifier. This link addition request frame 414 may inform the serving AP MLD 406 of a desire of the non-AP MLD 404 to roam to the roaming target AP MLD 408, as indicated by the identifier in the link addition request frame 414. The link addition request frame 414 may be sent as an over-the-air transmission.

Further, the link addition request frame 414 may include a container, such as an SRE. The SRE may include security context. The security context included in the SRE of the link addition request frame 414 may include the non-AP MLD's EPK (EPK-1) and SNonce. The serving AP MLD 406 may receive the link addition request frame 414 and tunnel the information over-the-DS to the roaming target AP MLD 408. For example, as shown, the serving AP MLD 406 may send the roaming target AP MLD 408 a link setup request 416 that includes the SRE with EPK-1 and SNonce.

The roaming target AP MLD 408 may send the serving AP MLD 406 a link setup response 418 over-the-DS. The link setup response 418 may include a decision concerning the link addition request frame 414 from the non-AP MLD 404. The decision may indicate whether the roaming target AP MLD 408 accepts the request or not. If the decision is to accept the link addition request frame 414 and create a link with the non-AP MLD 404, the link setup response 418 may include a container with security context for the roaming target AP MLD 408. For example, the link setup response 418 may include an SRE that includes the roaming target AP MLD's EPK (EPK-2), ANonce, and a Message Integrity Code (MIC). The roaming target AP MLD 408 may derive the MIC from EPK-1, EPK2, and SNonce.

The serving AP MLD 406 may send the link addition response frame 420 with the SRE to the non-AP MLD 404 over-the-air. The link addition response frame 420 sent from the serving AP MLD 406 may include all the security context that the roaming target AP MLD 408 included in the over-the-DS link setup response 418 (e.g., EPK-2, ANonce, and MIC).

The security context shared from the non-AP MLD 404 and the roaming target AP MLD 408, in combination with the ephemeral private keys of the non-AP MLD 404 and roaming target AP MLD 408, may be used to derive an ephemeral DHss which may be used to derive a PTK. For example, upon receipt of the security context, the non-AP MLD 404 may compute the DHss based on the EPK2 and the ephemeral private key of the non-AP MLD 404. The non-AP MLD 404 may use the DHss, ANonce, and SNonce to derive the PTK. Similarly, the roaming target AP MLD 408 may compute a DHss based on the EPK-1 and the ephemeral private key of the roaming target AP MLD 408.

The roaming target AP MLD 408 may use the DHss, ANonce, and SNonce to derive the PTK. The PTK may be used in data encryption and decryption processes for communications between the roaming target AP MLD 408 and the non-AP MLD 404.

In some embodiments, the non-AP MLD 404 may check whether the PTK it computed is correct. For example, the non-AP MLD 404 may send a link addition confirm frame 426 to the serving AP MLD 406. The non-AP MLD 404 may then forward the information from the link addition confirm frame 426 over-the-DS to the roaming target AP MLD 408 (e.g., link addition confirm 428). The link addition confirm frame 426 may include PTK verification information. For example, the link addition confirm frame 426 may include a container (e.g., an SRE) that includes a second MIC (e.g., MIC-1) The MIC may be generated using the PTK that the non-AP MLD 404 derived.

If the PTK calculated by the non-AP MLD 404 is incorrect, the roaming target AP MLD 408 may indicate that the PTK is wrong. If the PTK calculated by the non-AP MLD 404 is correct, the roaming target AP MLD 408 may respond with an acknowledgement (ACK) message or the roaming target AP MLD 308 may not provide feedback. In some embodiments, the roaming target AP MLD 308 only sends a response frame to the link addition confirm 328 when the PTK verification information is incorrect.

In some embodiments, a link handshake timeout 430 may be used. The link handshake timeout 430 may define a value after which PTK and context for link setup are expired. The link handshake timeout 430 may refer to a maximum duration between the link addition response frame 420 and the link addition confirm frame 426. In some embodiments, the serving AP MLD 406 may include the timeout value to the non-AP MLD 404 in link addition response frame 420. The roaming target AP MLD 408 and the non-AP MLD 404 may set a timer equal to the link handshake timeout 430. If the Link addition confirm frame is not received by the roaming target AP MLD 408 within the indicated link handshake timeout 430, the newly derived PTK and context for link setup may be considered expired.

Link setup may be complete 422 with the roaming target AP MLD 408 after the PTK is established and verified. As shown, the non-AP MLD 404 and the roaming target AP MLD 408 establish a logical connection. As the serving AP MLD 406 and the non-AP MLD 404 are still connected, they may continue to exchange data. The non-AP MLD 404 may initiate a route switch to the roaming target AP MLD 408 via the already established link.

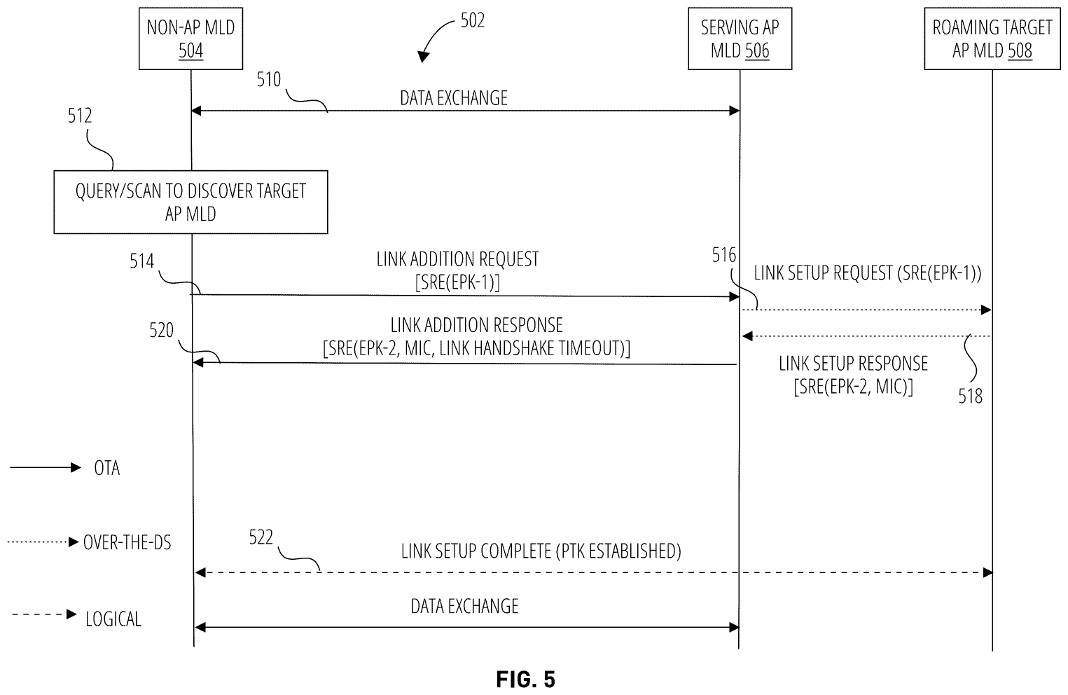

FIGS. 5-7 illustrate flow charts for PTK computation during link add phase of a seamless roaming procedure. A non-AP MLD can derive and verify a new temporal key (PTK) with Roaming Target AP MLD during link add phase the PTK using Protected Authentication Service Negotiation (PASN) authentication. This may allow the non-AP MLD to maintain the communication with serving AP MLD while adding link with the roaming target AP MLD. Further, by using PASN authentication the serving AP MLD may not be able to derive PTK without knowledge of the private keys of the non-AP MLD and the roaming target AP MLD.

In embodiments, using PASN authentication, ephemeral private keys of the non-AP MLD and the roaming target AP MLD may not be shared with the serving AP MLD. The non-AP MLD and roaming target AP MLD may share their ephemeral public key (EPK) with the serving AP MLD. The roaming target AP MLD may use non-AP MLD's EPK and its own ephemeral private key to derive an ephemeral DHss. The non-AP MLD may use AP MLD's EPK and its own ephemeral private key to derive an ephemeral DHss.

FIG. 5 illustrates an example signal flow diagram 502 for PTK computation during a link addition procedure before route switch using an SRE carried in the link addition request and response frames, in accordance with some embodiments. The link addition procedure may allow the non-AP MLD 504 to establish a connection with the roaming target AP MLD 508 before breaking the connection with the serving AP MLD 506. Further, the illustrated procedure introduces a container that includes security context (e.g., a seamless roaming element (SRE)) carried in management frames (e.g., link addition request and response action frames).

In the illustrated embodiment, the non-AP MLD 504 and the serving AP MLD 506 may have an established session and exchange data 510. The non-AP MLD 504 may query/scan 512 to discover roaming target AP MLD 508. The roaming target AP MLD 508 may represent an AP that the non-AP MLD 504 identifies as having a better signal strength than the serving AP MLD 506.

The non-AP MLD 504 may initiate roaming (e.g., transition from the serving AP MLD 506 to the roaming target AP MLD 508) through the serving AP MLD 506. The non-AP MLD 504 can send a management frame, such as a link addition request frame 514, to the serving AP MLD 506 with the roaming target AP MLD identifier. This link addition request frame 514 may inform the serving AP MLD 506 of a desire of the non-AP MLD 504 to roam to the roaming target AP MLD 508 as indicated by the identifier in the link addition request frame 514. The link addition request frame 514 may be sent as an over-the-air transmission.

Further, the link addition request frame 514 may include a container such as SRE. The SRE may include security context. The security context included in the SRE of the link addition request frame 514 may include the non-AP MLD's EPK (EPK-1). The serving AP MLD 506 may receive the link addition request frame 514 and tunnel the information over-the-DS to the roaming target AP MLD 508. For example, as shown, the serving AP MLD 506 may send the roaming target AP MLD 508 a link setup request 516 that includes the SRE with EPK-1.

The roaming target AP MLD 508 may send the serving AP MLD 506 a link setup response 518 over-the-DS. The link setup response 518 may include a decision concerning the link addition request frame 514 from the non-AP MLD 504. The decision may indicate whether the roaming target AP MLD 508 accepts the request or not. If the decision is to accept the link addition request frame 514 and create a link with the non-AP MLD 504, the link setup response 518 may include a container with security context for the roaming target AP MLD 508. For example, the link setup response 518 may include an SRE that includes the Roaming target AP MLD's EPK (EPK-2) and a Message Integrity Code (MIC).

The serving AP MLD 506 may send the link addition response frame 520 with the SRE to the non-AP MLD 504 over-the-air. The link addition response frame 520 sent from the serving AP MLD 506 may include all the security context that the roaming target AP MLD 508 included in the over-the-DS link setup response 518 (e.g., EPK-2 and MIC). Further, in some embodiments, the link addition response frame 520 from the serving AP MLD 506 may include a link handshake timeout. The link handshake timeout may define an interval after which the PTK and context for the link setup are expired.

The security context shared from the non-AP MLD 504 and the roaming target AP MLD 508 in combination with the ephemeral private keys of the non-AP MLD 504 and roaming target AP MLD 508 may be used to derive an ephemeral DHss which may be used to derive a PTK. For example, upon receipt of the security context, the non-AP MLD 504 may compute the DHss based on the EPK-2 and the ephemeral private key of the non-AP MLD 504. The non-AP MLD 504 may use the DHss to derive the PTK. Similarly, the roaming target AP MLD 508 may compute a DHss based on the EPK-1 and the ephemeral private key of the roaming target AP MLD 508. The roaming target AP MLD 508 may use the DHss to derive the PTK. The PTK may be used for in data encryption and decryption processes for communications between the roaming target AP MLD 508 and the non-AP MLD 504.

Link setup may be complete 522 with the roaming target AP MLD 508 after the PTK is established. As shown, the non-AP MLD 504 and the roaming target AP MLD 508 establish a logical connection. As the serving AP MLD 506 and the non-AP MLD 504 are still connected, they may continue to exchange data. The non-AP MLD 504 may initiate a route switch to the roaming target AP MLD 508 via the already established link.

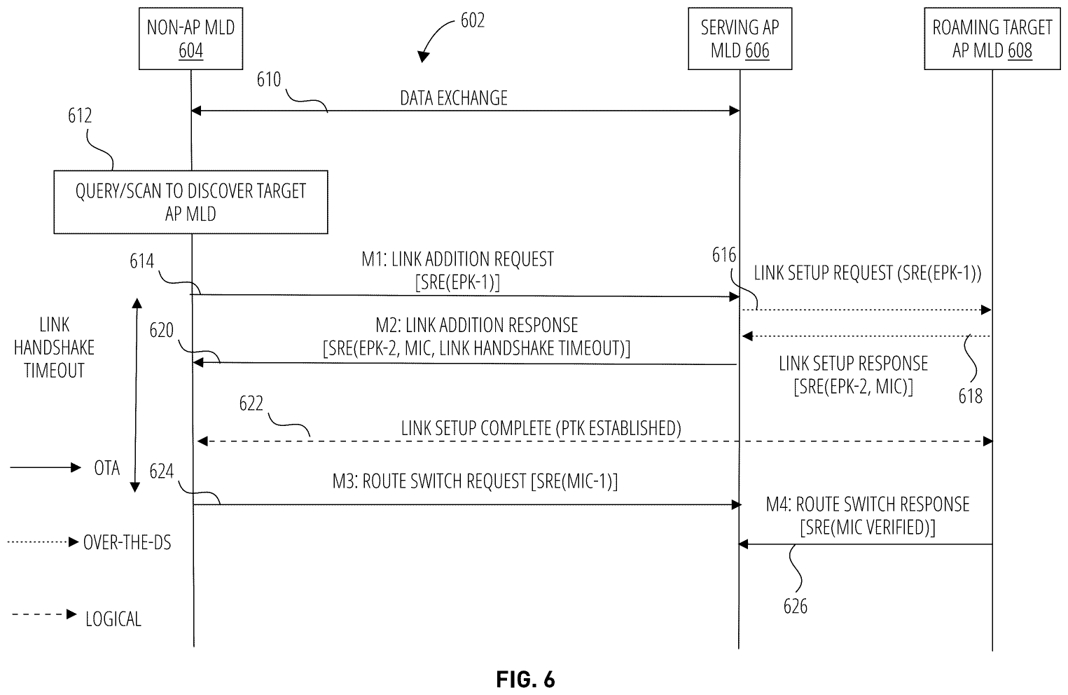

FIG. 6 illustrates an example signal flow diagram 602 for PTK computation during a link addition procedure and PTK verification, in accordance with some embodiments. The link addition procedure may allow the non-AP MLD 604 to establish a connection with the roaming target AP MLD 608 before breaking the connection with the serving AP MLD 606. Further, the illustrated procedure introduces a container that includes security context (e.g., a seamless roaming element (SRE)) carried in management frames (e.g., link addition request and response action frames).

In the illustrated embodiment, the non-AP MLD 604 and the serving AP MLD 606 may have an established session and exchange data 610. The non-AP MLD 604 may query/scan 612 to discover roaming target AP MLD 608. The roaming target AP MLD 608 may represent an AP that the non-AP MLD 604 identifies as having a better signal strength than the serving AP MLD 606.

The non-AP MLD 604 may initiate roaming (e.g., transition from the serving AP MLD 606 to the roaming target AP MLD 608) through the serving AP MLD 606. The non-AP MLD 604 can send a management frame, such as a link addition request frame 614, to the serving AP MLD 606 with the roaming target AP MLD identifier. This link addition request frame 614 may inform the serving AP MLD 606 of a desire of the non-AP MLD 604 to roam to the roaming target AP MLD 608 as indicated by the identifier in the link addition request frame 614. The link addition request frame 614 may be sent as an over-the-air transmission. The link addition request frame 614 may be a first message for the PASN authentication.

Further, the link addition request frame 614 may include a container such as SRE. The SRE may include security context. The security context included in the SRE of the link addition request frame 614 may include the non-AP MLD's EPK (EPK-1). The serving AP MLD 606 may receive the link addition request frame 614 and tunnel the information over-the-DS to the roaming target AP MLD 608. For example, as shown, the serving AP MLD 606 may send the roaming target AP MLD 608 a link setup request 616 that includes the SRE with EPK-1.

The roaming target AP MLD 608 may send the serving AP MLD 606 a link setup response 618 over-the-DS. The link setup response 618 may include a decision concerning the link addition request frame 614 from the non-AP MLD 604. The decision may indicate whether the roaming target AP MLD 608 accepts the request or not. If the decision is to accept the link addition request frame 614 and create a link with the non-AP MLD 604, the link setup response 618 may include a container with security context for the roaming target AP MLD 608. For example, the link setup response 618 may include an SRE that includes the Roaming target AP MLD's EPK (EPK-2) and a Message Integrity Code (MIC).

The serving AP MLD 606 may send the link addition response frame 620 with the SRE to the non-AP MLD 604 over-the-air. The link addition response frame 620 sent from the serving AP MLD 606 may include all the security context that the roaming target AP MLD 608 included in the over-the-DS link setup response 618 (e.g., EPK-2 and MIC). Further, in some embodiments, the link addition response frame 620 from the serving AP MLD 606 may include a link handshake timeout. The link handshake timeout may define an interval after which the PTK and context for the link setup are expired. The link handshake timeout may refer to the interval between link addition response frame 620 and route switch request frame 624. If the Route switch request frame 624 is not received within the indicated link handshake timeout interval, the newly derived PTK and context for link setup may be expired. The link addition response frame 620 may be a second message for the PASN authentication.

The security context shared from the non-AP MLD 604 and the roaming target AP MLD 608 in combination with the ephemeral private keys of the non-AP MLD 604 and roaming target AP MLD 608 may be used to derive an ephemeral DHss which may be used to derive a PTK. For example, upon receipt of the security context, the non-AP MLD 604 may compute the DHss based on the EPK-2 and the ephemeral private key of the non-AP MLD 604. The non-AP MLD 604 may use the DHss to derive the PTK. Similarly, the roaming target AP MLD 608 may compute a DHss based on the EPK-1 and the ephemeral private key of the roaming target AP MLD 608. The roaming target AP MLD 608 may use the DHss to derive the PTK. The PTK may be used for in data encryption and decryption processes for communications between the roaming target AP MLD 608 and the non-AP MLD 604.

Link setup may be complete 622 with the roaming target AP MLD 608 after the PTK is established. As shown, the non-AP MLD 604 and the roaming target AP MLD 608 establish a logical connection. As the serving AP MLD 606 and the non-AP MLD 604 are still connected, they may continue to exchange data.

The non-AP MLD 604 may initiate a route switch to the roaming target AP MLD 608 via the already established link. For instance, the non-AP MLD 604 may send a route switch request frame 624. The route switch request frame 624 may be used as a third message to share the MIC generated by the non-AP MLD with roaming target AP MLD after derivation of the new PTK. The route switch response frame 626 from the roaming target AP MLD 608 may be used as a fourth message to indicate that the MIC shared by non-AP MLD 604 is verified.

The benefits of the procedure in the signal flow diagram 602 may include that no additional frames may be needed for PTK verification. Instead, the PASN verification may piggyback on frames already used for the link setup and route switch. However, this may also cause there to be a reliance between link addition and route switch phase for PTK derivation and verification.

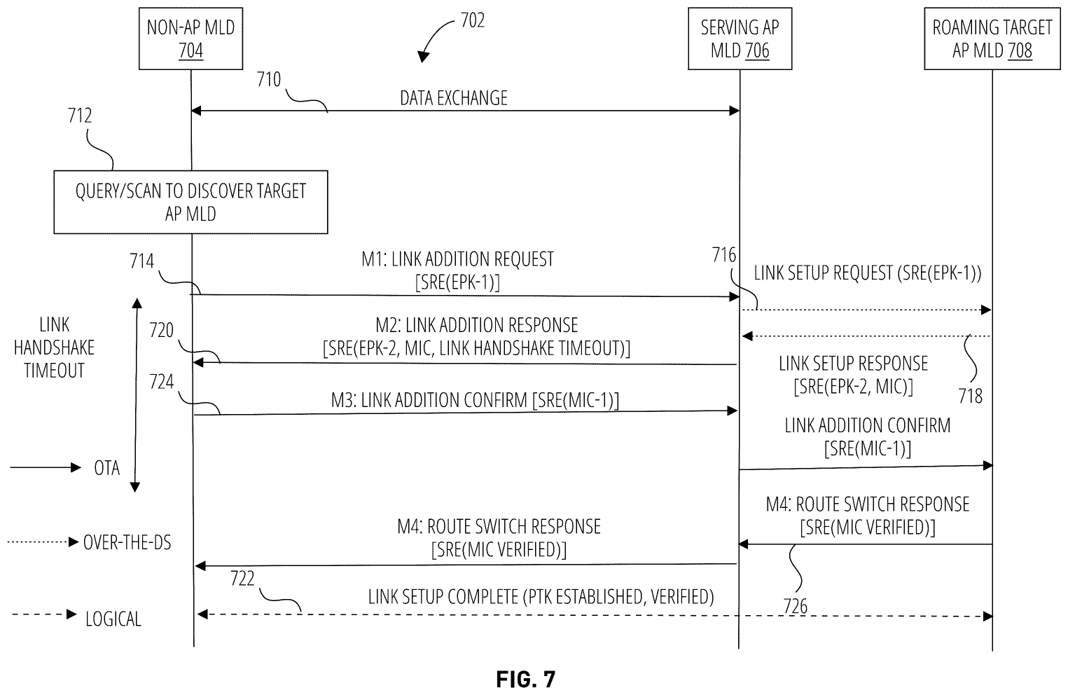

FIG. 7 illustrates an example signal flow diagram 702 for PTK verification after PTK derivation, in accordance with some embodiments. The link addition procedure may allow the non-AP MLD 704 to establish a connection with the roaming target AP MLD 708 before breaking the connection with the serving AP MLD 706. Further, the illustrated procedure introduces a container that includes security context (e.g., a seamless roaming element (SRE)) carried in management frames (e.g., link addition request and response action frames).

In the illustrated embodiment, the non-AP MLD 704 and the serving AP MLD 706 may have an established session and exchange data 710. The non-AP MLD 704 may query/scan 712 to discover roaming target AP MLD 708. The roaming target AP MLD 708 may represent an AP that the non-AP MLD 704 identifies as having a better signal strength than the serving AP MLD 706.

The non-AP MLD 704 may initiate roaming (e.g., transition from the serving AP MLD 706 to the roaming target AP MLD 708) through the serving AP MLD 706. The non-AP MLD 704 can send a management frame, such as a link addition request frame 714, to the serving AP MLD 706 with the roaming target AP MLD identifier. This link addition request frame 714 may inform the serving AP MLD 706 of a desire of the non-AP MLD 704 to roam to the roaming target AP MLD 708 as indicated by the identifier in the link addition request frame 714. The link addition request frame 714 may be sent as an over-the-air transmission. The link addition request frame 714 may be a first message for the PASN authentication.

Further, the link addition request frame 714 may include a container such as SRE. The SRE may include security context. The security context included in the SRE of the link addition request frame 714 may include the non-AP MLD's EPK (EPK-1). The serving AP MLD 706 may receive the link addition request frame 714 and tunnel the information over-the-DS to the roaming target AP MLD 708. For example, as shown, the serving AP MLD 706 may send the roaming target AP MLD 708 a link setup request 716 that includes the SRE with EPK-1.

The roaming target AP MLD 708 may send the serving AP MLD 706 a link setup response 718 over-the-DS. The link setup response 718 may include a decision concerning the link addition request frame 714 from the non-AP MLD 704. The decision may indicate whether the roaming target AP MLD 708 accepts the request or not. If the decision is to accept the link addition request frame 714 and create a link with the non-AP MLD 704, the link setup response 718 may include a container with security context for the roaming target AP MLD 708. For example, the link setup response 718 may include an SRE that includes the Roaming target AP MLD's EPK (EPK-2) and a Message Integrity Code (MIC).

The serving AP MLD 706 may send the link addition response frame 720 with the SRE to the non-AP MLD 704 over-the-air. The link addition response frame 720 sent from the serving AP MLD 706 may include all the security context that the roaming target AP MLD 708 included in the over-the-DS link setup response 718 (e.g., EPK-2 and MIC). Further, in some embodiments, the link addition response frame 720 from the serving AP MLD 706 may include a link handshake timeout. The link handshake timeout may define an interval after which the PTK and context for the link setup are expired. The link handshake timeout may refer to the interval between link addition response frame 720 and route link addition confirm frame 724. If the route link addition confirm frame 724 is not received within the indicated link handshake timeout interval, the newly derived PTK and context for link setup may be expired. The link addition response frame 720 may be a second message for the PASN authentication.

The security context shared from the non-AP MLD 704 and the roaming target AP MLD 708 in combination with the ephemeral private keys of the non-AP MLD 704 and roaming target AP MLD 708 may be used to derive an ephemeral DHss which may be used to derive a PTK. For example, upon receipt of the security context, the non-AP MLD 704 may compute the DHss based on the EPK-2 and the ephemeral private key of the non-AP MLD 704. The non-AP MLD 704 may use the DHss to derive the PTK. Similarly, the roaming target AP MLD 708 may compute a DHss based on the EPK-1 and the ephemeral private key of the roaming target AP MLD 708. The roaming target AP MLD 708 may use the DHss to derive the PTK. The PTK may be used for in data encryption and decryption processes for communications between the roaming target AP MLD 708 and the non-AP MLD 704.

In some embodiments, the non-AP MLD 704 may send a Link addition confirm frame 724 as 3rd message to the serving AP MLD 706 carrying PTK verification information, and the serving AP MLD 706 may send it to the Roaming target AP MLD 708. The roaming target AP MLD 708. A link addition confirm ACK frame 726 may be used as 4th message. The link addition confirm ACK frame 726 may be sent from the roaming target AP MLD 708 to acknowledge the MIC shared in the third message.

Link setup may be complete 722 with the roaming target AP MLD 708 after the PTK is established and verified. As shown, the non-AP MLD 704 and the roaming target AP MLD 708 establish a logical connection. As the serving AP MLD 706 and the non-AP MLD 704 are still connected, they may continue to exchange data.

The benefits of the procedure in the signal flow diagram 702 may include that verification done within standalone link setup phase. However, this may use additional frames (e.g., 6 messages for link setup and route switch) when compared to FT-based roaming.

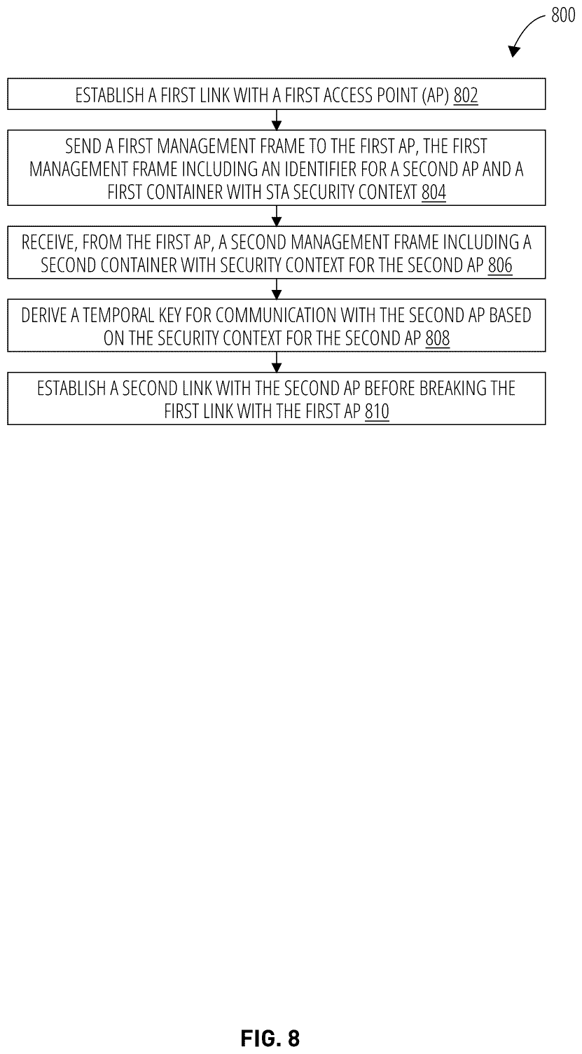

FIG. 8 illustrates a flow chart of an example method 800 performed by an STA (e.g., a non-AP MLD) in accordance with some embodiments. The illustrated method 800 comprises establishing 802 a first link with a first AP. The method 800 further comprises sending 804 a first management frame to the first AP, the first management frame including an identifier for a second AP and a first container with STA security context. The method 800 further comprises receiving 806, from the first AP, a second management frame including a second container with security context for the second AP. The method 800 further comprises deriving 808 a temporal key for communication with the second AP based on the security context for the second AP. The method 800 further comprises establishing 810 a second link with the second AP before breaking the first link with the first AP.

In some embodiments of the method 800, the first management frame comprises a link addition request, and the second management frame comprises a link addition response.

In some embodiments of the method 800, the first container comprises a first seamless roaming element (SRE) for the STA and the second container comprises a second SRE for the second AP.

In some embodiments of the method 800, the first SRE includes Supplicant Nonce (SNonce) and a first Key Holder Identifier for the STA (R0KH-ID), and the second SRE includes Authenticator Nonce (ANonce) and a second Key Holder Identifier for the second AP (R1KH-ID). In some embodiments, the temporal key is further based on a Pairwise Master key, the ANonce, and the SNonce.

In some embodiments of the method 800, the first SRE includes a first ephemeral public key (EPK) for the STA (EPK-1) and SNonce, the second SRE includes a second EPK for the second AP (EPK-2), ANonce, and a Message Integrity Code (MIC), and deriving the temporal key is further based on SNonce, the ANonce, and an ephemeral Diffie-Hellman shared secret (DHss) derived from an ephemeral private key of the STA and the EPK-2.

In some embodiments of the method 800, the temporal key comprises a Pairwise Transient Key (PTK).

In some embodiments, the method 800 further comprises sending a link addition confirm comprising temporal key verification information.

In some embodiments of the method 800, the temporal key verification comprises a MIC based on the temporal key.

In some embodiments, the method 800 further comprises performing a route switch to break the first link with the first AP and begin data exchange on the second link with the second AP.

In some embodiments of the method 800, the temporal key is verified using Protected Authentication Service Negotiation (PASN) authentication.

Embodiments contemplated herein include an apparatus comprising means to perform one or more elements of the method 800. This apparatus may be, for example, an apparatus of an STA (such as STA 1102 as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of an STA (such as a memory 1106 of an STA 1102, as described herein).

Embodiments contemplated herein include an apparatus comprising logic, modules, or circuitry to perform one or more elements of the method 800. This apparatus may be, for example, an apparatus of an STA (such as an STA 1102, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of an STA (such as an STA 1102, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of an STA (such as a processor(s) 1104 of an STA 1102, as described herein). These instructions may be, for example, located in the processor and/or on a memory of the STA (such as a memory 1106 of an STA 1102, as described herein).

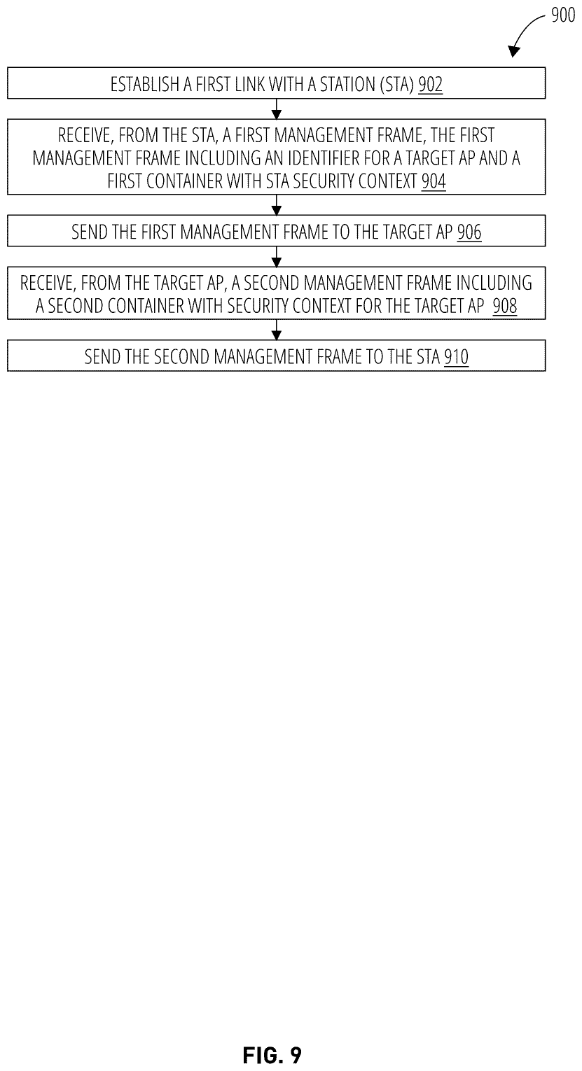

FIG. 9 illustrates a flow chart of an example method 900 performed by a serving AP in accordance with some embodiments. The illustrated method 900 comprises establishing 902 a first link with an STA. The method 900 further comprises receiving 904, from the STA, a first management frame, the first management frame including an identifier for a target AP and a first container with STA security context. The method 900 further comprises sending 906 the first management frame to the target AP. The method 900 further comprises receiving 908, from the target AP, a second management frame including a second container with security context for the target AP. The method 900 further comprises sending 910 the second management frame to the STA.

In some embodiments of the method 900, the first management frame comprises a link addition request, and the second management frame comprises a link addition response.

In some embodiments of the method 900, the first container comprises a first SRE for the STA and the second container comprises a second SRE for the target AP.

In some embodiments of the method 900, the first SRE includes SNonce and a first Key Holder Identifier for the STA (R0KH-ID), and the second SRE includes ANonce and a second Key Holder Identifier for the target AP (R1KH-ID).

In some embodiments of the method 900, he first SRE includes a first ephemeral public key (EPK) for the STA (EPK-1) and SNonce, wherein the second SRE includes a second EPK for the target AP (EPK-2), ANonce, and a MIC.

In some embodiments, the method 900 further comprises receiving a link addition confirm comprising temporal key verification information.

In some embodiments of the method 900, the temporal key verification comprises a MIC based on a temporal key.

In some embodiments of the method 900, the temporal key is verified using Protected Authentication Service Negotiation (PASN) authentication.

Embodiments contemplated herein include an apparatus comprising means to perform one or more elements of the method 900. This apparatus may be, for example, an apparatus of an AP (such as an AP 1118, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of an AP (such as a memory 1122 of an AP 1118, as described herein).

Embodiments contemplated herein include an apparatus comprising logic, modules, or circuitry to perform one or more elements of the method 900. This apparatus may be, for example, an apparatus of an AP (such as an AP 1118, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of an AP (such as an AP 1118, as described herein).

Embodiments contemplated herein include a signal as described in or related to one or more elements of the method 900.

Embodiments contemplated herein include a computer program or computer program product comprising instructions, wherein execution of the program by a processing element is to cause the processing element to carry out one or more elements of the method 900. The processor may be a processor of an AP (such as a processor(s) 1120 of an AP 1118, as described herein). These instructions may be, for example, located in the processor and/or on a memory of the AP (such as a memory 1122 of an AP 1118, as described herein).

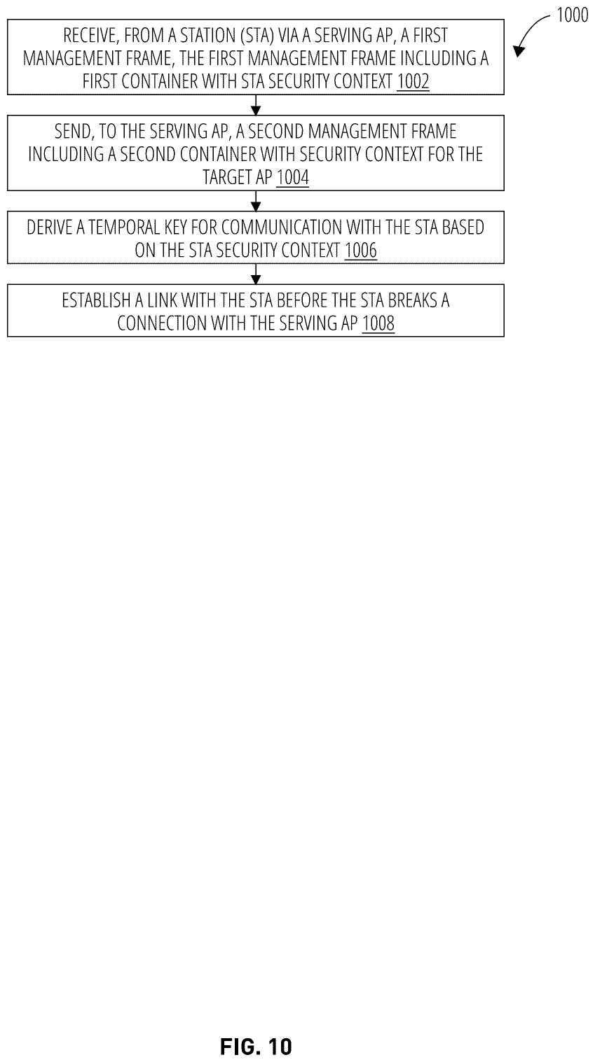

FIG. 10 illustrates a flow chart of an example method 1000 performed by a target AP in accordance with some embodiments. The illustrated method 1000 comprises receiving 1002, from an STA via a serving AP, a first management frame, the first management frame including a first container with STA security context. The method 1000 further comprises sending 1004, to the serving AP, a second management frame including a second container with security context for the target AP. The method 1000 further comprises deriving 1006 a temporal key for communication with the STA based on the STA security context. The method 1000 further comprises establishing 1008 a link with the STA before the STA breaks a connection with the serving AP.

In some embodiments of the method 1000, the first management frame comprises a link addition request, and the second management frame comprises a link addition response.

In some embodiments of the method 1000, the first container comprises a first seamless roaming element (SRE) for the STA and the second container comprises a second SRE for the target AP.

In some embodiments of the method 1000, the first SRE includes SNonce and a first Key Holder Identifier for the STA (R0KH-ID), and wherein the second SRE includes ANonce and a second Key Holder Identifier for the target AP (R1KH-ID).

In some embodiments of the method 1000, the first SRE includes a first EPK for the STA (EPK-1) and SNonce, the second SRE includes a second EPK for the target AP (EPK-2), ANonce, and a MIC, and wherein deriving the temporal key is further based on an ephemeral DHss derived from an ephemeral private key of the target AP.

In some embodiments of the method 1000, the temporal key comprises a PTK.

In some embodiments, the method 1000 further comprises receiving a link addition confirm comprising temporal key verification information.

In some embodiments of the method 1000, the temporal key verification comprises a MIC based on the temporal key.

In some embodiments of the method 1000, the temporal key is verified using Protected Authentication Service Negotiation (PASN) authentication.

Embodiments contemplated herein include an apparatus comprising means to perform one or more elements of the method 1000. This apparatus may be, for example, an apparatus of an AP (such as an AP 1118, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of an AP (such as a memory 1122 of an AP 1118, as described herein).

Embodiments contemplated herein include an apparatus comprising logic, modules, or circuitry to perform one or more elements of the method 1000. This apparatus may be, for example, an apparatus of an AP (such as an AP 1118, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of an AP (such as an AP 1118, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of an AP (such as a processor(s) 1120 of an AP 1118, as described herein). These instructions may be, for example, located in the processor and/or on a memory of the AP (such as a memory 1122 of an AP 1118, as described herein).

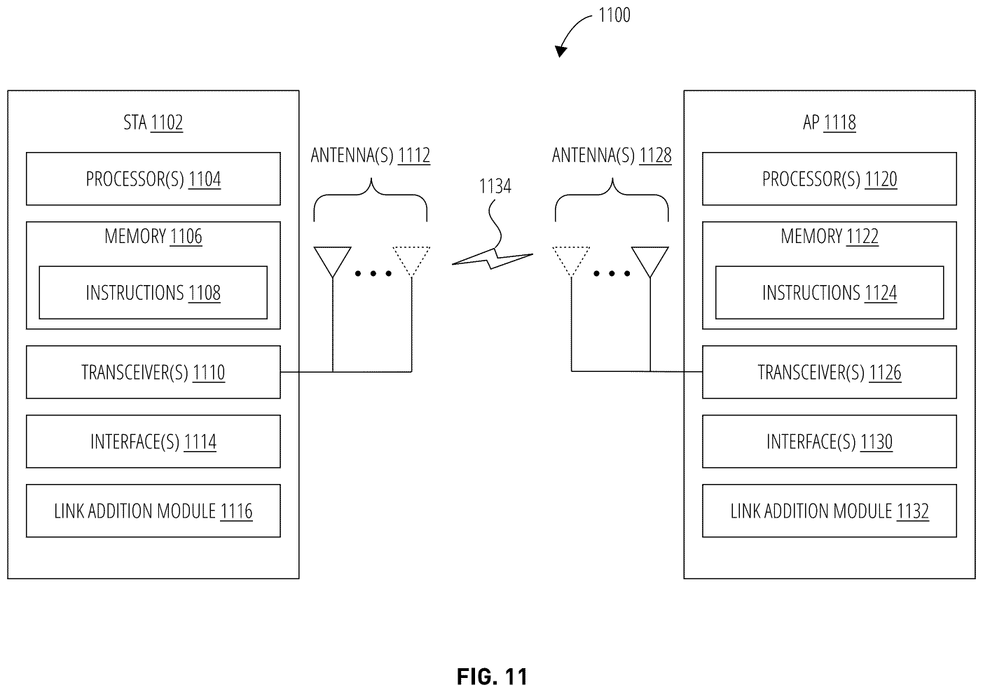

FIG. 11 illustrates a system 1100 for performing signaling 1134 between an STA 1102 and an AP 1118, according to embodiments disclosed herein. The system 1100 may be a portion of a wireless communications system as herein described. The STA 1102 may be, for example, a UE of a wireless communication system. The AP 1118 may be, for example, an access point of a wireless communication system.

The STA 1102 may include one or more processor(s) 1104. The processor(s) 1104 may execute instructions such that various operations of the STA 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The STA 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The STA 1102 may include one or more transceiver(s) 1110 that may include radio frequency (RF) transmitter circuitry and/or receiver circuitry that use the antenna(s) 1112 of the STA 1102 to facilitate signaling (e.g., the signaling 1134) to and/or from the STA 1102 with other devices (e.g., the AP 1118).

The STA 1102 may include one or more antenna(s) 1112 (e.g., one, two, three, four, or more). For embodiments with multiple antenna(s) 1112, the STA 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the STA 1102 may be accomplished according to precoding (or digital beamforming) that is applied at the STA 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the STA 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The STA 1102 may include one or more interface(s) 1114. The interface(s) 1114 may be used to provide input to or output from the STA 1102. For example, an STA 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The STA 1102 may include a link addition module 1116. The link addition module 1116 may be implemented via hardware, software, or combinations thereof. For example, the link addition module 1116 may be implemented as a processor, circuit, and/or instructions 1108 stored in the memory 1106 and executed by the processor(s) 1104. In some examples, the link addition module 1116 may be integrated within the processor(s) 1104 and/or the transceiver(s) 1110. For example, the link addition module 1116 may be implemented by a combination of software components (e.g., executed by a DSP or a general processor) and hardware components (e.g., logic gates and circuitry) within the processor(s) 1104 or the transceiver(s) 1110.

The link addition module 1116 may be used for various aspects of the present disclosure, for example, aspects of FIGS. 3-7.

The AP 1118 may include one or more processor(s) 1120. The processor(s) 1120 may execute instructions such that various operations of the AP 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The AP 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The AP 1118 may include one or more transceiver(s) 1126 that may include RF transmitter circuitry and/or receiver circuitry that use the antenna(s) 1128 of the AP 1118 to facilitate signaling (e.g., the signaling 1134) to and/or from the AP 1118 with other devices (e.g., the STA 1102).

The AP 1118 may include one or more antenna(s) 1128 (e.g., one, two, three, four, or more). In embodiments having multiple antenna(s) 1128, the AP 1118 may perform MIMO, digital beamforming, analog beamforming, beam steering, etc., as has been described.

The AP 1118 may include one or more interface(s) 1130. The interface(s) 1130 may be used to provide input to or output from the AP 1118. For example, an AP 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The AP 1118 may include a link addition module 1132. The link addition module 1132 may be implemented via hardware, software, or combinations thereof. For example, the link addition module 1132 may be implemented as a processor, circuit, and/or instructions 1124 stored in the memory 1122 and executed by the processor(s) 1120. In some examples, the link addition module 1132 may be integrated within the processor(s) 1120 and/or the transceiver(s) 1126. For example, the link addition module 1132 may be implemented by a combination of software components (e.g., executed by a DSP or a general processor) and hardware components (e.g., logic gates and circuitry) within the processor(s) 1120 or the transceiver(s) 1126.

The link addition module 1132 may be used for various aspects of the present disclosure, for example, aspects of FIGS. 3-7.

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with an STA or AP as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc., of one embodiment can be used in another embodiment. The parameters, attributes, aspects, etc., are merely described in one or more embodiments for clarity, and it is recognized that the parameters, attributes, aspects, etc., can be combined with or substituted for parameters, attributes, aspects, etc., of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a station (STA), the method comprising:
establishing a first link with a first access point (AP);
sending a first management frame to the first AP, the first management frame including an identifier for a second AP and a first container with STA security context;
receiving, from the first AP, a second management frame including a second container with AP security context to the second AP;
deriving a temporal key for communication with the second AP based on the security context for the second AP; and
establishing a second link with the second AP before breaking the first link with the first AP.

2. The method of claim 1, wherein the first management frame is received over-the-air and comprises a link addition request, and the second management frame is received over-the-air and comprises a link addition response.

3. The method of claim 1, wherein the first container comprises a first seamless roaming element (SRE) for the STA and the second container comprises a second SRE for the second AP.

4. The method of claim 3, wherein the first SRE includes Supplicant Nonce (SNonce) and a first Key Holder Identifier for the STA (R0KH-ID), and
wherein the second SRE includes Authenticator Nonce (ANonce) and a second Key Holder Identifier for the second AP (R1KH-ID), and
wherein deriving the temporal key is further based on a Pairwise Master key, the ANonce, and the SNonce.

5. The method of claim 3, wherein the first SRE includes a first ephemeral public key (EPK) for the STA (EPK-1) and SNonce,
wherein the second SRE includes a second EPK for the second AP (EPK-2), ANonce, and a Message Integrity Code (MIC), and
wherein deriving the temporal key is further based on the SNonce, the ANonce, and an ephemeral Diffie-Hellman shared secret (DHss) derived from an ephemeral private key of the STA and the EPK-2.

6. The method of claim 1, wherein the temporal key comprises a Pairwise Transient Key (PTK).

7. The method of claim 1, further comprising sending a link addition confirm comprising temporal key verification information.

8. The method of claim 7, wherein the temporal key verification comprises a MIC based on the temporal key.

9. The method of claim 1, further comprising performing a route switch with the second AP to break the first link with the first AP and begin data exchange on the second link with the second AP.

10. The method of claim 1, wherein the first SRE includes a first ephemeral public key (EPK) for the STA (EPK-1),
wherein the second SRE includes a second EPK for the second AP (EPK-2), and a Message Integrity Code (MIC), and
wherein the temporal key is verified using Protected Authentication Service Negotiation (PASN) authentication.

11. A method performed by a serving access point (AP), the method comprising:
establishing a first link with a station (STA);
receiving, from the STA, a first management frame over-the-air, the first management frame including an identifier for a target AP and a first container with STA security context;
sending the first management frame to the target AP;
receiving, from the target AP, a second management frame including a second container with security context for the target AP; and
sending the second management frame over-the-air to the STA.

12. The method of claim 11, wherein the first management frame comprises a link addition request, and the second management frame comprises a link addition response.

13. The method of claim 11, wherein the first container comprises a first seamless roaming element (SRE) for the STA and the second container comprises a second SRE for the target AP.

14. The method of claim 13, wherein the first SRE includes Supplicant Nonce (SNonce) and a first Key Holder Identifier for the STA (R0KH-ID), and
wherein the second SRE includes Authenticator Nonce (ANonce) and a second Key Holder Identifier for the target AP (R1KH-ID).

15. The method of claim 13, wherein the first SRE includes a first ephemeral public key (EPK) for the STA (EPK-1) and SNonce,
wherein the second SRE includes a second EPK for the target AP (EPK-2), ANonce, and a Message Integrity Code (MIC).

16. The method of claim 11, further comprising receiving a link addition confirm comprising temporal key verification information.

17. The method of claim 16, wherein the temporal key verification comprises a MIC based on a temporal key.

18. The method of claim 16, wherein the first SRE includes a first ephemeral public key (EPK) for the STA (EPK-1),
wherein the second SRE includes a second EPK for the second AP (EPK-2), and a Message Integrity Code (MIC), and
wherein the temporal key is verified using Protected Authentication Service Negotiation (PASN) authentication.

19. A method performed by a target access point (AP), the method comprising:
receiving, from a station (STA) via a serving AP, a first management frame, the first management frame including a first container with STA security context;
sending, to the serving AP, a second management frame including a second container with security context to the target AP;
deriving a temporal key for communication with the STA based on the STA security context; and
establishing a link with the STA before the STA breaks a connection with the serving AP.

20. The method of claim 19, wherein the first management frame comprises a link addition request, and the second management frame comprises a link addition response.
